(19) United States
(12) Patent Application Publication
(10) Pub. No.: US 2015/0278913 A1
(43) Pub. Date: Oct. 1, 2015

(54) INFORMATION PRESENTATION METHOD

(71) Applicant: Panasonic Intellectual Property Corporation of America, Torrance, CA (US)

(72) Inventor: KOTARO SAKATA, Osaka (JP)

(21) Appl. No.: 14/645,405

(22) Filed: Mar. 11, 2015

(30) Foreign Application Priority Data
Mar. 28, 2014 (JP) 2014-068645

(51) Int. Cl. G06Q 30/06

(52) U.S. Cl. CPC G06Q 30/0631

(57) ABSTRACT

First rating information is input by a first user who has received a service from a service providing person and indicates a rating for the service providing person. Second rating information is input by a second user other than the first user and indicates ratings for service providing persons including the above service providing person. A service providing person to be recommended to the first user is searched for, using the first rating information and the second rating information. Presentation information for presenting the first user the service providing person to be recommended to the first user found as a result of the search is generated. The presentation information is transmitted to a terminal device.

### BACKGROUND

1. Technical Field

The present disclosure relates to a method for presenting a user with information for recommending a service providing person.

2. Description of the Related Art

Conventionally, a system is known in which a beauty operator (an example of a service providing person) is introduced to a user (for example, see Japanese Unexamined Patent Application Publication No. 2008-9675).

### SUMMARY

However, further improvement has been required in Japanese Unexamined Patent Application Publication No. 2008-9675 above.

In one general aspect, the techniques disclosed here feature an information presentation method for providing a terminal device with presentation information. In this method, first rating information and second rating information are obtained; the first rating information is information that is alternatively selected by a first user who has received a service from a service providing person, from choices indicating preset ratings for the service providing person, and the second rating information contains keywords that are extracted from text information arbitrarily input by a second user other than the first user and indicate attributes of service providing persons including the above service providing person. A service providing person to be recommended to the first user is searched for, using the first rating information and the second rating information. Presentation information for presenting the first user the service providing person to be recommended to the first user found as a result of the search is generated. The presentation information is transmitted to the terminal device.

The above aspect has allowed further improvement.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIGS. 1A to 1C illustrate an overview of an information presentation system according to an embodiment of the present disclosure;

FIG. 2 is a block diagram illustrating an example of a configuration of the information presentation system according to the embodiment of the present disclosure;

FIG. 3 is a flowchart illustrating an example of operation of a server device according to the embodiment of the present disclosure;

FIG. 4 illustrates an example of beauty operator information according to the embodiment of the present disclosure;

FIG. 5 illustrates an example of user history information according to the embodiment of the present disclosure;

FIGS. 6A and 6B illustrate examples of an input screen of first rating information according to the embodiment of the present disclosure;

FIG. 7 illustrates an example of an input screen of second rating information according to the embodiment of the present disclosure;

FIGS. 8A and 8B illustrate display examples of presentation information according to the embodiment of the present disclosure;

FIG. 9 illustrates an example of the input screen of the second rating information according to the embodiment of the present disclosure;

FIG. 10 illustrates an example of a hardware configuration of a computer that implements, by software, functions of an apparatus and the server device according to the embodiment of the present disclosure;

FIG. 11 illustrates a first service type (in-house data center type);

FIG. 12 illustrates a second service type (IaaS use type);

FIG. 13 illustrates a third service type (PaaS use type); and

FIG. 14 illustrates a fourth service type (SaaS use type).

### DETAILED DESCRIPTION

### Underlying Knowledge Forming Basis of the Present Disclosure

The inventor has found that the following problem occurs in techniques described in Japanese Unexamined Patent Application Publication No. 2008-9675 above.

In the system in Japanese Unexamined Patent Application Publication No. 2008-9675, a terminal device first transmits information input by a user (for example, a personal profile and conditions for a desired beauty operator) to a server device. Then, the server device searches for a beauty operator who matches the above input information from a preset personal data group for each beauty operator, and transmits, to the terminal device, information for introducing the beauty operator to the user. The user can thereby receive an introduction of his or her desired beauty operator. However, the personal data group for each beauty operator that is used to search for a beauty operator is not based on ratings for the beauty operators by users who have actually taken treatment. Accordingly, there is a problem in that the beauty operator to be introduced may not match the user's preference.

The inventor has thus studied the following improvement measures to solve the above problem.

(1) An information presentation method in one aspect of the present disclosure provides a terminal device with presentation information. In this method, first rating information and second rating information are obtained; the first rating information is information that is alternatively selected by a first user who has received a service from a service providing person, from choices indicating preset ratings for the service providing person, and the second rating information contains keywords that are extracted from text information arbitrarily input by a second user other than the first user and indicate attributes of service providing persons including the above service providing person. A service providing person to be recommended to the first user is searched for, using the first rating information and the second rating information. Presentation information for presenting the first user the service providing person to be recommended to the first user found as a result of the search is generated. The presentation information is transmitted to the terminal device.

According to the present aspect, by simply selecting a rating alternatively from choices indicating ratings for a service providing person, the user can receive a recommendation for a service providing person who matches the user's preference from among service providing persons rated by other people.

(2) In the above aspect, the service providing person to be recommended to the first user may be further searched for based on a shop or area specified by the first user.

According to the present aspect, the user can receive a recommendation for a service providing person who matches the user's preference in the desired shop or area.

(3) In the above aspect, time point information indicating a time point at which the first user received the service from the service providing person may be associated with the first rating information. The average time from when the first user received the service to when the first user receives the service next time may be calculated, using a plurality of pieces of the time point information for a plurality of pieces of the first rating information. The presentation information may be generated at a timing at which the average time has elapsed since the latest time point at which the first user received the service.

According to the present aspect, the user can receive presentation information without requesting the presentation information.

(4) In the above aspect, the service providing person may be a beauty operator, and the second rating information may include at least any of looks of the beauty operator, a counseling skill of the beauty operator, a conversation skill of the beauty operator, a treatment skill of the beauty operator, and an atmosphere of the beauty operator, as an attribute of the service providing person.

According to the present aspect, the user can receive presentation information about a beauty operator who is more suitable for him or her.

(5) In the above aspect, the second rating information may include an attribute of the service providing person and an attribute value corresponding to the attribute. The attribute value may be decided using the number of times a keyword indicating the attribute is extracted from the text information.

According to the present aspect, a detailed and specific preference criterion is created.

An embodiment of the present disclosure will now be described in detail with reference to the drawings.

### <Overall View of a Provided Service>

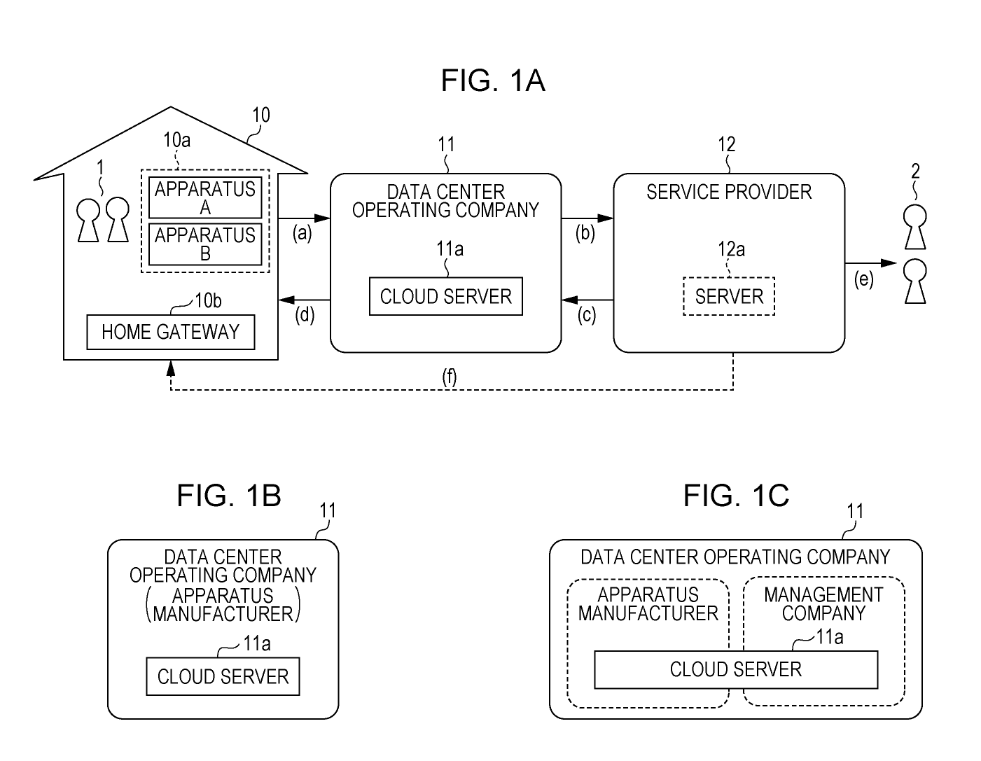

An overall view of a provided service according to the present embodiment will first be described with reference to FIGS. 1A to 1C. FIGS. 1A to 1C illustrate an overview of an information presentation system in the present embodiment. FIG. 1A illustrates an overall view of the information presentation system in the present embodiment.

A group 10 is, for example, a corporation, organization, family, or the like, irrespective of the size. The group 10 includes an apparatus A and an apparatus B as a plurality of apparatuses 10a (for example, apparatuses 100, which will be described later) and a home gateway 10b.

Each of the plurality of apparatuses 10a is an apparatus that can connect to the Internet (for example, a smartphone, tablet, PC, TV, or the like). However, even if any of the plurality of apparatuses 10a cannot connect to the Internet by itself, the apparatus 10a has only to be an apparatus that can connect to the Internet through the home gateway 10b. The group 10 includes also a user 1 who uses the plurality of apparatuses 10a. The user 1 is, for example, an employee of a shop (for example, a beauty shop) or a customer of the employee.

A data center operating company 11 includes a cloud server 11a. The cloud server 11a is a virtualization server that cooperates with various apparatuses through the Internet. The data center operating company 11 conducts data management, management of the cloud server 11a, operation of a data center for conducting such management, and the like. Details of the work conducted by the data center operating company 11 will be described later.

The data center operating company 11 here is not limited to a company that only conducts data management, operation of the cloud server 11a, or the like. For example, when an apparatus manufacturer that develops and manufactures one apparatus of the plurality of apparatuses 10a also conducts data management, management of the cloud server 11a, and the like, the apparatus manufacturer corresponds to the data center operating company 11 (see FIG. 1B).

Further, the data center operating company 11 is not limited to one company. For example, when an apparatus manufacturer and another management company conduct data management and operation of the cloud server 11a jointly or separately, either or both are assumed to correspond to the data center operating company 11 (see FIG. 1C).

A service provider 12 holds a server 12a (for example, a server device 200, which will be described later). A plurality of servers 12a may be provided for different purposes.

The home gateway 10b is not necessarily required for the above service. For example, in cases such as one in which the cloud server 11a performs all data management activities, the home gateway 10b is not required. An apparatus that cannot connect to the Internet by itself may not be included, as in the case in which every apparatus in the group 10 is connected to the Internet.

A flow of information in the above service will next be described. First, the apparatus A or the apparatus B in the group 10 individually transmits information (such as beauty operator information, user history information, first rating information, and second rating information, which will be described later, for example) to the cloud server 11a in the data center operating company 11. The cloud server 11a collects the information from the apparatus A or the apparatus B ((a) in FIG. 1A).

The above information may be provided directly from the plurality of apparatuses 10a themselves to the cloud server 11a through the Internet. Alternatively, the above information may be collected temporarily from the plurality of apparatuses 10a to the home gateway 10b, and then provided from the home gateway 10b to the cloud server 11a.

Next, the cloud server 11a in the data center operating company 11 provides the service provider 12 with the collected information in a constant unit. The constant unit here may be a unit in which the information collected by the data center operating company 11 can be organized and provided to the service provider 12, or may be a unit requested by the service provider 12. Although the constant unit is described, the unit may not be constant, and an amount of information to be provided may vary depending on the situation.

The information collected in the cloud server 11a is saved in the server 12a held by the service provider 12 as necessary ((b) in FIG. 1A). Then, the service provider 12 organizes the saved information into information that matches a service to be provided to a user (for example, first information for input, second information for input, and presentation information, which will be described later) and provides the user with the information. The user who is provided with the information may be the user 1 who uses the plurality of apparatuses 10a or a user 2 outside the group 10.

In a method for providing the user with the service, for example, the information may be provided directly from the service provider 12 to the user ((f) and (e) in FIG. 1A). In the method for providing the user with the service, for example, the information may pass through the cloud server 11a in the data center operating company 11 again, and may be provided to the user ((c) and (d) in FIG. 1A). The cloud server 11a in the data center operating company 11 may organize the collected information into information that matches the service to be provided to the user, and provide the service provider 12 with the information.

The user 1 and the user 2 may be different or identical.

### <Configuration of the Information Presentation System>

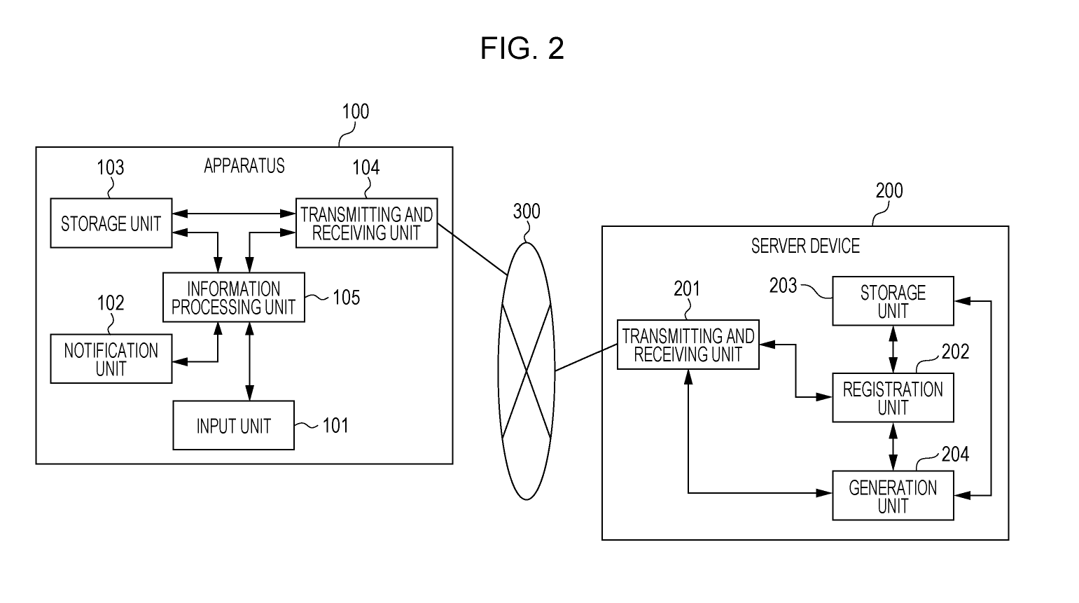

A configuration example of the information presentation system according to the present embodiment will next be described with reference to FIG. 2. FIG. 2 is a block diagram illustrating an example of a configuration of the information presentation system in the present embodiment.

As illustrated in FIG. 2, the information presentation system has the apparatus 100 and the server device 200.

In FIG. 2, the apparatus 100 and the server device 200 are connected through a network 300. The network 300 may be a wireless network, wired network, or network with a mixture of wired and wireless networks.

Only one apparatus 100 is illustrated in FIG. 2, but more than one apparatus 100 is assumed to be provided. For example, an apparatus 100 used by a user and an apparatus 100 used by another user are provided.

A configuration of the apparatus 100 will first be described.

The apparatus 100 is an information processing device (terminal device) that can communicate with the server device 200, and is, for example, a smartphone, tablet, PC, TV, or the like. The apparatus 100 is used by a service providing person or a user who is a customer of the service providing person. The present embodiment is described with an example in which the service providing person is a beauty operator.

The user can use an information presentation service using the apparatus 100. The information presentation service is a service that provides the user with presentation information for recommending a beauty operator who matches the user's preference. Details of the presentation information will be described later.

A beauty operator (including an employee or the like of a shop to which the beauty operator belongs) can register beauty operator information and user history information using the apparatus 100. The beauty operator information is information for each beauty operator to be recommended and includes information items such as the name of the beauty operator and the shop to which the beauty operator belongs. The user history information is information indicating a history of visits to a beauty shop and includes, for example, information items such as the name of the user and the name of the beauty shop which the user has visited. Details of the beauty operator information and the user history information will be described later.

The apparatus 100 includes an input unit 101, a notification unit 102, a storage unit 103, a transmitting and receiving unit 104, and an information processing unit 105.

The input unit 101 is an input device such as a button or touch panel.

For example, the input unit 101 accepts an input operation for beauty operator information, user history information, first rating information, second rating information, or recommendation request information. The first rating information is information in which the user who has taken treatment from a beauty operator makes an overall rating for the beauty operator. For example, the first rating information is information in which an overall rating for a beauty operator is alternatively selected. The second rating information is information in which the user who has taken treatment from a beauty operator makes an attribute-by-attribute rating for the beauty operator. For example, the second rating information is information in which an attribute-by-attribute rating for a beauty operator is selected as a numeric value. The recommendation request information is information in which the user requests a recommendation for a beauty operator (that is, information in which the user requests presentation information from the server device 200). Details of the first rating information and the second rating information will be described later.

The notification unit 102 is a displaying device such as a display, or an output device such as a speaker.

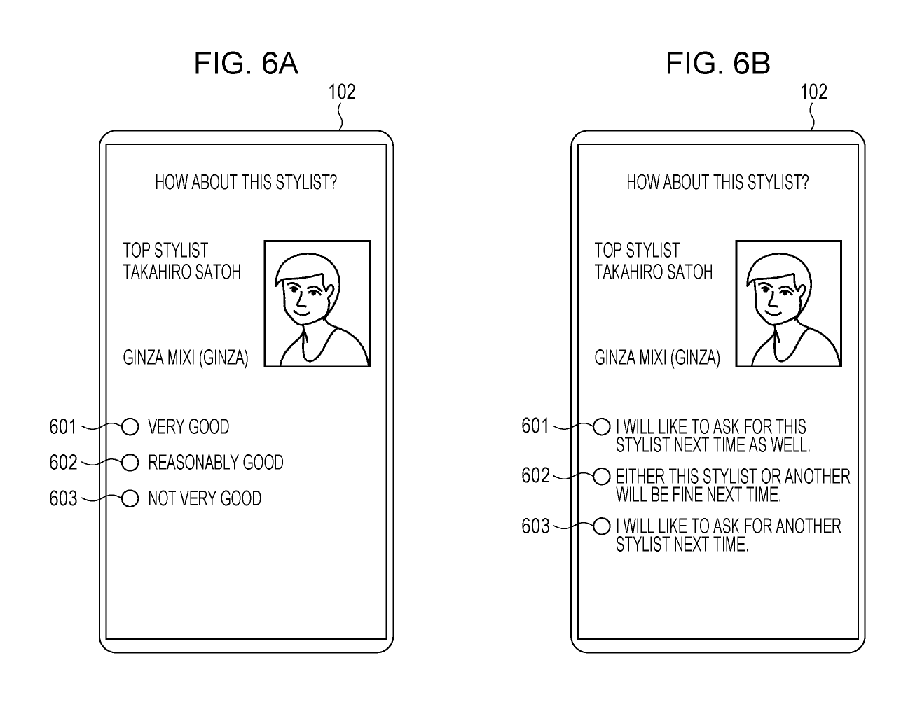

For example, the notification unit 102 displays first information for input, second information for input, or presentation information. The first information for input is image information for allowing the user to input the first rating information. The second information for input is image information for allowing the user to input the second rating information. Display examples of the first information for input, the second information for input, and the presentation information will be described later with reference to FIGS. 6A and 6B, FIG. 7, and FIGS. 8A and 8B, respectively.

The storage unit 103 is a storage device such as a memory or hard disk device.

For example, the storage unit 103 stores first information for input, second information for input, or presentation information received from the server device 200.

The transmitting and receiving unit 104 is a communication interface unit that transmits information to another device and receives information transmitted by another device.

For example, the transmitting and receiving unit 104 transmits beauty operator information, user history information, first rating information, second rating information, or recommendation request information to the server device 200.

Moreover, for example, the transmitting and receiving unit 104 receives first information for input, second information for input, or presentation information from the server device 200.

The information processing unit 105 is a control device, such as a processor, that performs various information processing tasks.

For example, the information processing unit 105 makes the storage unit 103 temporarily store first information for input, second information for input, or presentation information received by the transmitting and receiving unit 104 from the server device 200, and then reads any of these pieces of information at a predetermined timing and makes the notification unit 102 display the information.

Moreover, for example, the information processing unit 105 makes the transmitting and receiving unit 104 transmit, to the server device 200, beauty operator information, user history information, first rating information, second rating information, or recommendation request information accepted by the input unit 101.

The configuration of the apparatus 100 has been described above.

A configuration of the server device 200 will next be described.

The server device 200 is an information processing device that receives various types of information described above from both the apparatus 100 used by the user and the apparatus 100 used by a beauty operator, generates first information for input, second information for input, or presentation information based on the various types of information, and transmits the presentation information to the user's apparatus 100.

The server device 200 includes a transmitting and receiving unit 201, a registration unit 202, a storage unit 203, and a generation unit 204.

The transmitting and receiving unit 201 is a communication interface unit that transmits information to another device and receives information transmitted by another device.

For example, the transmitting and receiving unit 201 receives beauty operator information or user history information from the beauty operator's apparatus 100.

Moreover, for example, the transmitting and receiving unit 201 transmits first information for input, second information for input, or presentation information generated in the generation unit 204 to the user's apparatus 100.

Further, for example, the transmitting and receiving unit 201 receives first rating information, second rating information, or recommendation request information from the user's apparatus 100.

The registration unit 202 is a control device, such as a processor, that performs various information processing tasks.

For example, the registration unit 202 registers, with the storage unit 203, beauty operator information or user history information received by the transmitting and receiving unit 201 from the beauty operator's apparatus 100.

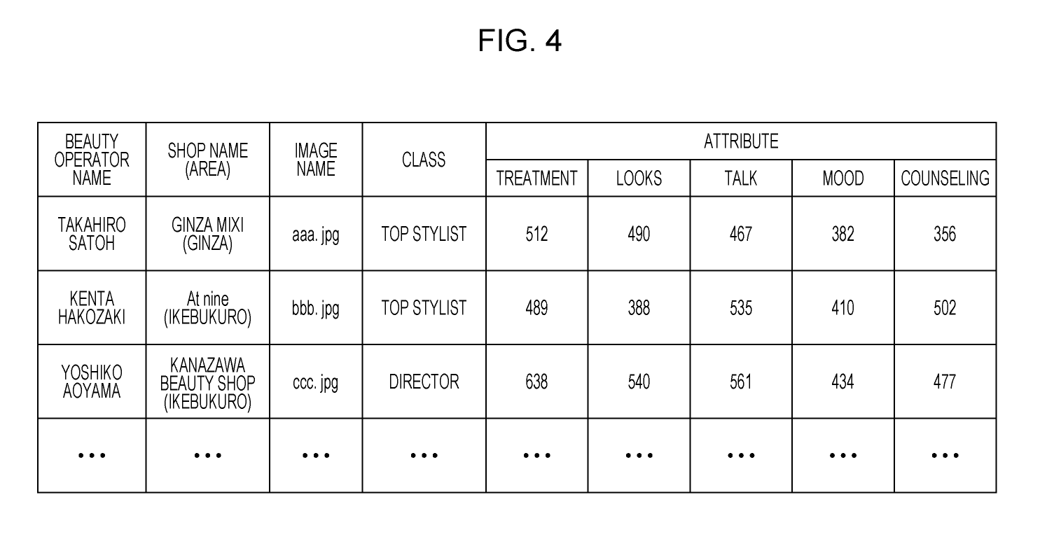

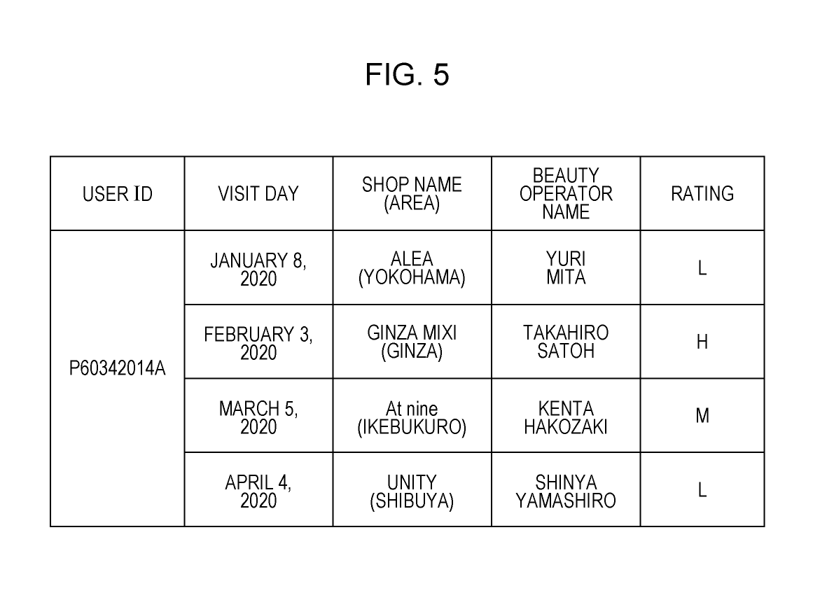

For example, the registration unit 202 registers, with the storage unit 203, first rating information or second rating information received by the transmitting and receiving unit 201 from the user's apparatus 100. For example, the registration unit 202 registers the first rating information in the user history information. Moreover, for example, the registration unit 202 registers the second rating information in the beauty operator information. A specific example of the registration processing will be described later with reference to FIGS. 4 and 5.

The storage unit 203 is a storage device such as a memory or hard disk device.

For example, the storage unit 203 stores beauty operator information, user history information, first rating information, and second rating information registered by the registration unit 202. As described above, the first rating information is registered in the user history information and the second rating information is registered in the beauty operator information.

Moreover, for example, the storage unit 203 stores individual pieces of template information for first information for input, second information for input, and presentation information.

The generation unit 204 is a control device, such as a processor, that performs various information processing tasks.

For example, when the registration unit 202 registers user history information, the generation unit 204 reads the user history information and beauty operator information from the storage unit 203, and based on these pieces of information, the generation unit 204 generates first information for input and second information for input. A specific example of the generation processing will be described later.

Then, the generation unit 204 makes the transmitting and receiving unit 201 transmit the generated first information for input and second information for input to the user's apparatus 100.

Moreover, for example, when the transmitting and receiving unit 201 receives recommendation request information, the generation unit 204 reads user history information and beauty operator information from the storage unit 203, and decides a preference criterion based on these pieces of information. The preference criterion is a criterion that indicates which of attributes of a beauty operator (attributes in FIG. 4, which will be described later) the user prefers (places importance on). A specific example of the decision processing will be described later.

Then, the generation unit 204 searches the beauty operators registered in the beauty operator information for a beauty operator who matches the decided preference criterion. A specific example of the search processing will be described later.

Then, the generation unit 204 extracts information about the beauty operator found as a result of the search from the beauty operator information, and generates presentation information based on the extracted information. A specific example of the generation processing will be described later.

Then, the generation unit 204 makes the transmitting and receiving unit 201 transmit the generated presentation information to the user's apparatus 100.

The configuration of the server device 200 has been described above.

### <Operation of the Server Device 200>

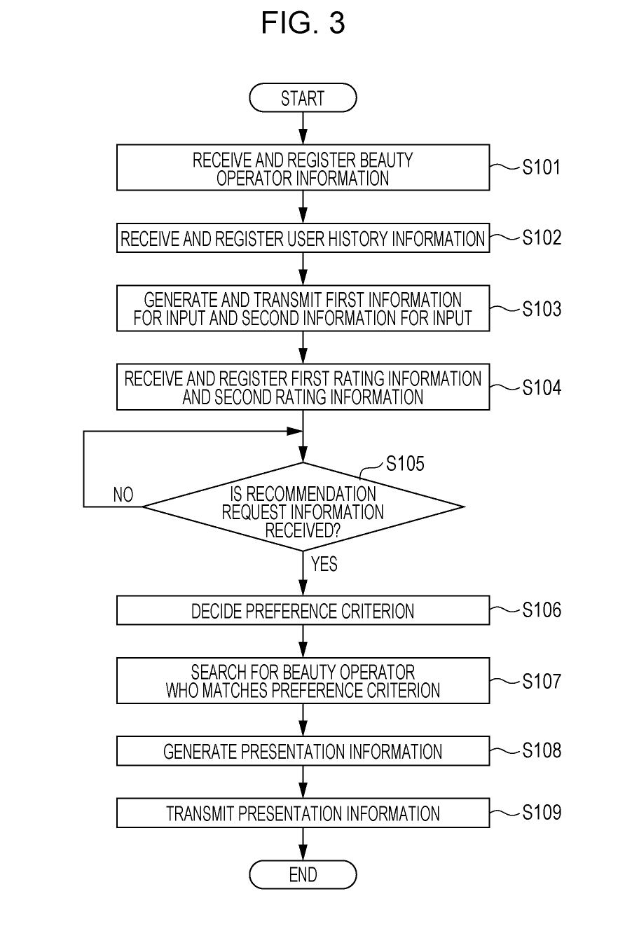

An operation example of the server device 200 of the information presentation system according to the present embodiment will next be described with reference to FIG. 3. FIG. 3 is a flowchart illustrating an operation example of the server device 200 in the present embodiment.

In step S101, the transmitting and receiving unit 201 receives beauty operator information from a beauty operator's apparatus 100, and the registration unit 202 registers the beauty operator information with the storage unit 203.

An example of beauty operator information will be described here with reference to FIG. 4. FIG. 4 illustrates an example of the beauty operator information registered with the storage unit 203.

As illustrated in FIG. 4, the beauty operator information includes information items of the beauty operator name, shop name (area), image name, class, and attributes for each beauty operator.

The beauty operator name is the name of a beauty operator.

The shop name (area) is the name of a shop to which the beauty operator belongs and the area where the shop is located.

The image name is the name (identification information) of beauty operator image information. The beauty operator image information may be, for example, a photograph of the face or upper body of the beauty operator, a portrait of the beauty operator, or the like. The beauty operator image information, which is not illustrated, is stored in the storage unit 203 in association with the image name.

The class is the class of the beauty operator. The class is, for example, a director, top stylist, stylist, assistant, or the like.

The attributes are the attributes of the beauty operator that are rated by users. The users here are a plurality of users who have taken treatment from the beauty operator indicated by the beauty operator name. In FIG. 4, five types of attributes (treatment, looks, talk, mood, and counseling, details of which will be described later) are preset as examples. As illustrated in FIG. 4, for example, a numeric value (referred to below as an attribute value) is associated with each attribute. Each attribute value is an integrated value of numeric values (examples of second rating information) input by the plurality of users. The larger the attribute value of an attribute, the higher the rating for the attribute made by the plurality of users. Each attribute value is registered based on the second rating information. Details of this will be described later.

In FIG. 4, the information items of the beauty operator name, shop name (area), image name (and the beauty operator image information corresponding to the image name), and class are added, changed, or deleted when beauty operators in each shop perform operations from the apparatus 100 for inputting and transmitting the information items to the server device 200 as appropriate.

The example of the beauty operator information has been described above. The description of the flow in FIG. 3 will now be resumed.

In step S102, the transmitting and receiving unit 201 receives user history information from the beauty operator's apparatus 100, and the registration unit 202 registers the user history information with the storage unit 203.

An example of user history information will be described here with reference to FIG. 5. FIG. 5 illustrates an example of the user history information registered with the storage unit 203.

As illustrated in FIG. 5, the user history information includes information items of the user ID, visit day, shop name (area), beauty operator name, and, rating.

The user ID is an ID by which a user of the apparatus 100 who can use an information presentation service can be identified. The user ID is, for example, prestored in the storage unit 203 in association with the user name. This information item is the user ID here, but may be the user name.

The visit day is a time point at which the user visited a beauty shop and took treatment from a beauty operator. In FIG. 5, this information item is the date as an example, but may include a time of day.

The shop name (area) is the name of a shop which the user visited and the area where the shop is located.

The beauty operator name is the name of a beauty operator who provided the user with treatment.

The rating is a rating made by the user for the beauty operator who provided treatment. The user here is the user indicated by the user ID. The rating is a value that indicates a choice (an example of first rating information) input by the user. The rating is registered based on the first rating information. Details of this will be described later. For example, one of the three level ratings H, M, and L (H indicating the highest rating and L indicating the lowest rating) is registered.

In FIG. 5, the information items of the user ID, visit day, shop name (area) and beauty operator name are registered with the storage unit 203 when beauty operators in each shop perform operations from the apparatus 100 for inputting and transmitting the information items to the server device 200 after a visit by the user. These information items are registered in chronological order.

Although the user history information for one user is illustrated in FIG. 5, user history information for a plurality of users is registered with the storage unit 203 on a user-by-user basis.

The example of the user history information has been described above. The description of the flow in FIG. 3 will now be resumed.

In step S103, the generation unit 204 generates first information for input and second information for input and makes the transmitting and receiving unit 201 transmit these pieces of information to the user's apparatus 100.

An example of processing for generating the first information for input and the second information for input will be described here with reference to FIGS. 4 and 5.

The processing for generating the first information for input will first be described.

When the registration unit 202 registers the user history information with the storage unit 203, the generation unit 204 reads the user history information and the beauty operator information from the storage unit 203. As an example here, it is assumed that the beauty operator information in FIG. 4 and the user history information in FIG. 5 are read. It is also assumed that the latest registered user history information in FIG. 5 includes the visit day “Feb. 3, 2020”, the shop name (area) “Ginza MIXI (Ginza)”, and the beauty operator name “Takahiro Satoh”. At this point in time, the rating by the user for “Takahiro Satoh” is a blank.

Next, the generation unit 204 extracts the information items of the image name and class corresponding to “Ginza MIXI (Ginza)” and “Takahiro Satoh”, which are included in the latest user history information, from the beauty operator information in FIG. 4. The information items of the image name “aaa.jpg” and the class “top stylist” are extracted here. Moreover, the generation unit 204 reads the beauty operator image information associated with the extracted image name from the storage unit 203.

Next, the generation unit 204 reads template information for the first information for input from the storage unit 203. Then, the generation unit 204 generates image information in which the information items of the beauty operator name, shop name (area), and class (for example, text information) and the beauty operator image information are included in the template information. The image information thus generated is the first information for input.

The processing for generating the second information for input will next be described.

When the generation of the first information for input is completed, the generation unit 204 reads template information for the second information for input from the storage unit 203, and generates image information in which the same information as the first information for input (for example, the information items of the beauty operator name, shop name (area), and class (for example, text information) and the beauty operator image information) is included in the template information. The image information thus generated is the second information for input.

The example of the processing for generating the first information for input and the second information for input has been described above.

The first information for input and the second information for input described above are transmitted from the server device 200 to the user's apparatus 100. The processing operation in the apparatus 100 will next be described.

When the transmitting and receiving unit 104 receives the first information for input and the second information for input, the information processing unit 105 makes the storage unit 103 temporarily store these pieces of information, and then reads the information at a predetermined timing and makes the notification unit 102 display the information. The first information for input or the second information for input is thereby displayed on the notification unit 102. The user can switch the display of the first information for input and the second information for input as appropriate by performing a display switch operation on the input unit 101.

FIGS. 6A and 6B illustrate examples in which the first information for input is displayed on the notification unit 102 of the user's apparatus 100. As illustrated in FIGS. 6A and 6B, the information items of the beauty operator name, shop name (area), and class and the beauty operator image information are displayed on the notification unit 102. Choices 601 to 603 from which the user makes a selection as the first rating information are also displayed. The choices 601 to 603 are information items included in the template information. The choices 601, 602, and 603 correspond to the three ratings H, M, and L set in the above user history information in FIG. 5, respectively. The first information for input displayed on the notification unit 102 is the information in FIG. 6A or FIG. 6B.

The user performs an operation on the input unit 101 for making a selection from among the choices 601 to 603 as a rating for a beauty operator from whom the user has taken treatment. For example, for a high rating, the user performs an operation for selecting the choice 601. On the other hand, for a low rating, the user performs an operation for selecting the choice 603. For a borderline case, the user performs an operation for selecting the choice 602.

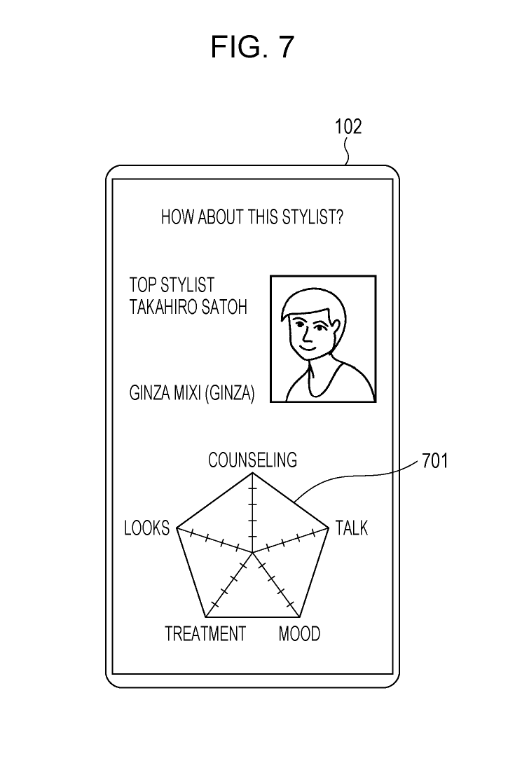

Next, FIG. 7 illustrates an example in which the second information for input is displayed on the notification unit 102 of the user's apparatus 100. As illustrated in FIG. 7, the information items of the beauty operator name, shop name (area), and class and the beauty operator image information are displayed on the notification unit 102. An input field 701 in which the user inputs a numeric value for each attribute as the second rating information is also displayed. The input field 701 is displayed, for example, in radar chart format. The input field 701 is an information item included in the template information. Five attributes shown in the input field 701 are the same as the five attributes set in the above beauty operator information in FIG. 4.

The user performs an operation on the input unit 101 for inputting an numeric value for each attribute in the input field 701 as a rating for a beauty operator from whom the user has taken treatment. The rating for each attribute is one of the five levels 1 to 5, with 5 indicating the highest rating and 1 indicating the lowest rating. In the “Counseling” item, for example, the user inputs a numeric value indicating a rating of whether counseling before the treatment was appropriate. In the “Looks” item, for example, the user inputs a numeric value indicating a rating of whether the appearance of the beauty operator is favorable to the user. In the “Treatment” item, for example, the user inputs a numeric value indicating a rating of whether the haircut or permanent waving technique was excellent. In the “Mood” item, for example, the user inputs a numeric value indicating a rating of whether the user liked the atmosphere of the beauty operator or his or her attitude toward the user. In the “Talk” item, for example, the user inputs a numeric value indicating a rating of whether the user enjoyed a conversation with the beauty operator.

The information processing unit 105 makes the transmitting and receiving unit 104 transmit the first rating information (any of the choices 601 to 603) input in the first information for input and the second rating information (the numeric values of the attributes in the input field 701) input in the second information for input to the server device 200. The processing operation in the apparatus 100 has been described above. The description of the flow in FIG. 3 will now be resumed.

In step S104, the transmitting and receiving unit 201 of the server device 200 receives the first rating information and the second rating information from the user's apparatus 100, and the registration unit 202 registers the first rating information and the second rating information with the storage unit 203.

An example of processing for registering the first rating information and the second rating information will be described here with reference to FIGS. 4 and 5.

The processing for registering the first rating information will first be described. As an example here, it is assumed that the latest information in the user history information in FIG. 5 includes the visit day “Feb. 3, 2020”, the shop name (area) “Ginza MIXI (Ginza)”, and the beauty operator name “Takahiro Satoh”, and the rating is a blank.

The registration unit 202 registers the first rating information for the rating in the user history information in FIG. 5. For example, when the first rating information is an input of the choice 601, the value “H” corresponding to the input is registered in the blank. The rating “H” for the beauty operator name “Takahiro Satoh” is thereby registered as illustrated in FIG. 5.

The processing for registering the second rating information will next be described. As an example here, it is assumed that attribute values obtained by integrating the second rating information from a plurality of users are registered in the attributes of the beauty operator name “Takahiro Satoh” in the beauty operator information in FIG. 4.

The registration unit 202 registers the second rating information for the attributes in the beauty operator information in FIG. 4. That is, the registration unit 202 adds the numeric values of the attributes input as the second rating information to the individual attribute values already registered in the beauty operator information in FIG. 4. As illustrated in FIG. 4, the result is that the attributes of the beauty operator name “Takahiro Satoh” are, for example, the treatment, looks, talk, mood, and counseling in descending order of the attribute values.

Thus, the first rating information input by one user is registered in the rating in the user history information in FIG. 5, while the second rating information input by a plurality of users is integrated and registered in the attributes in the beauty operator information in FIG. 4.

The example of the processing for registering the first rating information and the second rating information has been described above. The description of the flow in FIG. 3 will now be resumed.

In step S105, the generation unit 204 determines whether recommendation request information is received from the user's apparatus 100. As described above, the recommendation request information is information in which the user requests the transmission of presentation information from the server device 200. The user who desires a recommendation for a beauty operator performs an operation on the input unit 101 of the apparatus 100 for transmitting the recommendation request information. The recommendation request information is thereby transmitted from the user's apparatus 100 to the server device 200.

As a result of the above determination, when the recommendation request information is not received (step S105: NO), the flow returns to step S105. On the other hand, as a result of the above determination, when the recommendation request information is received (step S105: YES), the flow proceeds to step S106.

In step S106, the generation unit 204 reads, from the storage unit 203, the beauty operator information and the user history information for the user who transmitted the recommendation request information, and determines a preference criterion based on these pieces of information. As described above, the preference criterion is a criterion that indicates which of the five attributes of the beauty operator the user prefers (places importance on).

An example of processing for deciding the preference criterion will be described here with reference to FIGS. 4 and 5. As an example here, it is assumed that the latest information in the user history information in FIG. 5 includes the visit day “Apr. 4, 2020”, the shop name (area) “UNITY (Shibuya)”, the beauty operator name “Shinya Yamashiro”, and the rating “L”. That is, in this example, the user who has the user name “Nishiyama” associated with the user ID “P60342014A” visited the shop that has the shop name “UNITY” and then desired a recommendation for a beauty operator.

First, the generation unit 204 searches the user history information in FIG. 5 for a beauty operator name and shop name (area) with the rating of H or M. As an example here, “Takahiro Satoh” and “Ginza MIXI (Ginza)” as well as “Kenta Hakozaki” and “At nine (Ikebukuro)” are detected.

Next, the generation unit 204 extracts the attributes corresponding to the beauty operator name and shop name (area) found as a result of the search from the beauty operator information in FIG. 4 in descending order of the attribute values. As an example here, as the attributes of “Takahiro Satoh” and “Ginza MIXI (Ginza)”, the treatment, looks, talk, mood, and counseling are extracted in descending order of the attribute values, and as the attributes of “Kenta Hakozaki” and “At nine (Ikebukuro)”, the talk, counseling, treatment, mood, and looks are extracted in descending order of the attribute values.

Next, the generation unit 204 assigns a preset weight to each of the extracted attributes of each beauty operator. For example, the generation unit 204 multiplies each attribute value of a beauty operator with the rating of H by a weight coefficient of 2. Moreover, the generation unit 204 multiplies each attribute value of a beauty operator with the rating of M by a weight coefficient of 1. For example, because the rating for “Takahiro Satoh” is H, each attribute value is multiplied by 2. On the other hand, because the rating for “Kenta Hakozaki” is M, each attribute value is multiplied by 1.

Next, the generation unit 204 totalizes the weighted attribute values for each attribute. For example, when a result of weighting the attribute value of the treatment for “Takahiro Satoh” is 1024 and a result of weighting the attribute value of the treatment for “Kenta Hakozaki” is 489, a total value of the treatment is calculated as 1513. Total values of the other attributes are also calculated as described above.

Next, the generation unit 204 decides the ranking of the top three attributes among the five calculated total values as a preference criterion. For example, when the attributes are the treatment, talk, looks, mood, and counseling in descending order of the total values, the ranking “first rank: treatment, second rank: talk, third rank: looks” is decided as a preference criterion. Although the top three attributes are decided here for the preference criterion, the number of attributes is not limited to three.

The example of the processing for deciding the preference criterion has been described above. The description of the flow in FIG. 3 will now be resumed.

In step S107, the generation unit 204 searches the beauty operator information in FIG. 4 for a beauty operator who matches the preference criterion. As an example here, the beauty operator name “Yoshiko Aoyama” is detected as the beauty operator who matches the preference criterion “first rank: treatment, second rank: talk, third rank: looks”. If a beauty operator who has attributes that match the ranking indicated in the preference criterion does not exist, the generation unit 204 may ignore the ranking and search for a beauty operator who has the top three attributes that are the same as those in the preference criterion. The beauty operator thus detected is recommended to the user through the presentation information. A plurality of beauty operators may be detected.

In step S108, the generation unit 204 generates the presentation information based on the user history information and the beauty operator information.

An example of processing for generating the presentation information will be described here with reference to FIGS. 4 and 5.

First, the generation unit 204 extracts the information items of the shop name (area), image name, and class associated with the detected beauty operator name from the beauty operator information in FIG. 4. As an example here, the information items of the shop name (area) “Kanazawa beauty shop (Ikebukuro)”, the image name “ccc.jpg”, and the class “director” associated with the detected beauty operator name “Yoshiko Aoyama” are extracted. Moreover, the generation unit 204 reads the beauty operator image information associated with the extracted image name from the storage unit 203.

Next, the generation unit 204 extracts the user ID from the user history information in FIG. 5. As an example here, the user ID “P60342014A” is extracted. Then, the generation unit 204 reads the user name associated with the extracted user ID from the storage unit 203. As an example here, the user name “Nishiyama” is read.

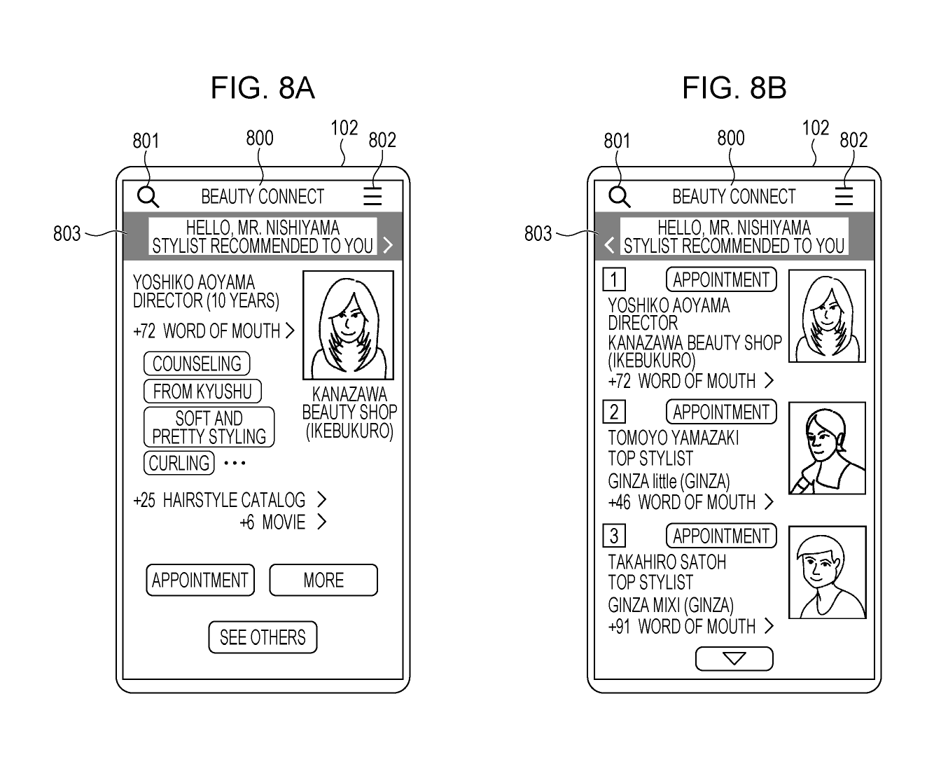

Next, the generation unit 204 reads template information for the presentation information from the storage unit 203, and generates image information in which the extracted information items are included in the template information. The image information is the presentation information. As an example here, the presentation information is generated in which the information items of the user name “Nishiyama”, the beauty operator name “Yoshiko Aoyama”, the shop name (area) “Kanazawa beauty shop (Ikebukuro)”, and the class “director” (for example, text information) and the beauty operator image information associated with the image name “ccc.jpg” are included in the template information. Display examples of the presentation information will be described later with reference to FIGS. 8A and 8B.

The example of the processing for generating the presentation information has been described above. The description of the flow in FIG. 3 will now be resumed.

In step S109, the generation unit 204 makes the transmitting and receiving unit 201 transmit the generated presentation information to the user's apparatus 100. A method for transmitting the presentation information is, for example, e-mail or the like. Then, the presentation information is received and displayed on the user's apparatus 100. The processing for displaying the presentation information on the apparatus 100 has already been described, and therefore the description is omitted here.

Display examples of the presentation information on the apparatus 100 will be described here with reference to FIGS. 8A and 8B. FIGS. 8A and 8B illustrate the display examples of the presentation information on the apparatus 100. FIG. 8A illustrates the example in which one beauty operator is displayed on one screen, and FIG. 8B illustrates the example in which a plurality of beauty operators are displayed on one screen. For example, the user can arbitrarily switch between the display form in FIG. 8A and the display form in FIG. 8B by performing a display switch operation on the input unit 101 (a button in a message 803, which will be described later).

As illustrated in FIG. 8A, a service name 800 and buttons 801 and 802 are displayed at the top of the notification unit 102. The button 801 is a button operated by the user to search for a beauty operator, shop, or the like. When this button is operated, for example, a search page allowing the user to search for a beauty operator, shop, or the like is displayed on the notification unit 102. The button 802 is a button operated by the user to return to a menu. When this button is operated, for example, a menu list page is displayed on the notification unit 102.

The message 803 including the user name is displayed below the service name 800. The message 803 includes a display switch button (“>” in the drawing). The display switch button is a button operated by the user to switch the display form in FIG. 8A to the display form in FIG. 8B. When this button is operated, for example, a page in FIG. 8B, which will be described later, is displayed on the notification unit 102.

The information for one beauty operator to be recommend (class, beauty operator name, shop name (area), and image) is displayed below the message. As illustrated in FIG. 8A, information items of the number of years of beauty operator experience, a user rating score, where the beauty operator comes from, an attribute with a high rating, a moving image or still image of the treatment that the beauty operator provided in the past, and so on (these information items are also included in advance in the beauty operator information in FIG. 4) may be displayed as the beauty operator information.

The “Appointment” button, the “More” button, and the “See others” button are displayed below the information for one beauty operator on the notification unit 102. The “Appointment” button is a button operated by the user to make an appointment with the recommended beauty operator. When this button is operated, for example, an appointment page in the website of the shop to which the beauty operator belongs is displayed on the notification unit 102. The “More” button is a button operated by the user to view detailed information for the recommend beauty operator. When this button is operated, for example, a beauty operator introduction page in the website of the shop to which the beauty operator belongs is displayed on the notification unit 102. The “See others” button is a button operated by the user to view information for other recommend beauty operators. When a plurality of beauty operators have been detected in the server device 200 and this button is operated, for example, presentation information for other beauty operators is displayed on the notification unit 102.

As illustrated in FIG. 8B, the service name 800, the buttons 801 and 802, the message 803 that includes the user name (including a display switch button), and the information for three recommend beauty operators (class, beauty operator name, shop name (area), image, and the like) are displayed on the notification unit 102, as in FIG. 8A. Recommendation ranks 1 to 3 are also displayed for the recommended beauty operators. A recommendation rank indicates that the smaller the number, the more closely a beauty operator matches the user's preference. The recommendation ranks are decided by the generation unit 204, depending on the extent to which the attribute values registered in the beauty operator information match the preference criterion.

The “Appointment” button, the “More” button, and the “See others” button are displayed on the notification unit 102, as in FIG. 8A. The details of the buttons have already been described, and therefore the description is omitted here. When the “See others” button is operated, for example, information for three beauty operators of ranks 4 to 6 is displayed.

The service name 800, the message, and the buttons illustrated in FIGS. 8A and 8B are information items included in the template information.

The display examples of the presentation information on the apparatus 100 have been described above.

Thus, the present embodiment is characterized by providing the user with presentation information generated based on ratings for beauty operators by users who have actually taken treatment. The user can thereby receive a recommendation for a beauty operator who matches his or her preference.

### <Variations of the Embodiment>

Although the embodiment of the present disclosure has been described above, various variations may be made without departing from the spirit of the present disclosure. Variations of the above embodiment will now be described.

### (First Variation)

The above description includes an example in which the user who has taken treatment inputs both first rating information and second rating information, but, to receive presentation information, the input of the second rating information is not necessarily required and the user has only to input the first rating information for at least one beauty operator. To create a preference criterion, however, the input of the choice 601 or the choice 602 illustrated in FIGS. 6A and 6B is required as the first rating information.

According to this variation, by simply making a simplified rating for a predetermined beauty operator, the user can receive a recommendation for a beauty operator who matches the preference from among beauty operators rated by other users.

### (Second Variation)

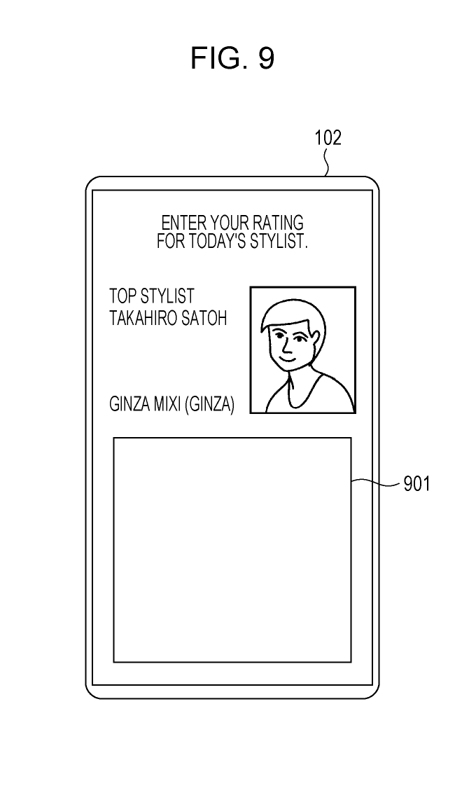

Second information for input may be image information by which the user can arbitrarily submit a rating for a beauty operator. FIG. 9 illustrates a display example of the second information for input in this case. In FIG. 9, an input field 901 is displayed on the notification unit 102. In the input field 901, the user can freely fill in an impression of or a rating for the beauty operator from whom the user has taken treatment. The text information input in the input field 901 is transmitted from the apparatus 100 to the server device 200, and is then subjected to keyword analysis processing by the registration unit 202 of the server device 200. The keyword analysis processing is a known technique, and therefore the description is omitted here. A preset keyword is thereby extracted from the text information.

The preset keyword is a keyword indicating an attribute of a beauty operator and is, for example, any of the following. For example, keywords related to the looks include “stylish”, “cool”, “cute”, and the like. For example, keywords related to the talk include “having a lot of things to talk about”, “good listener”, and the like. For example, keywords related to the treatment include “good at curling”, “excelling at short hairstyling”, and the like. For example, keywords related to the mood include “lively”, “friendly”, and the like. For example, keywords related to the counseling include “having a lot of knowledge”, “making appropriate suggestions”, and the like. The preset keywords are not limited to keywords related to the above five attributes.

The registration unit 202 registers the extracted keyword in the relevant attribute in the beauty operator information in FIG. 4. In this case, the attribute value is, for example, the number of times the keyword is extracted. That is, the larger the number of times the keyword is written, the larger the attribute value.

Thus, according to this variation, as compared with a case in which attributes are preset as described in the above embodiment, a more detailed and specific preference criterion can be created, and a beauty operator to be recommended is detected based on the preference criterion. Therefore, the user can receive a recommendation for a beauty operator who matches the preference more closely.

### (Third Variation)

When the user requests presentation information, the user may specify a shop or area. In this case, when the generation unit 204 searches the beauty operator information for a beauty operator based on a preference criterion, the generation unit 204 makes the search based on the shop or area specified by the user. The user can thereby receive a recommendation for a beauty operator in the desired shop or area.

### (Fourth Variation)

The generation unit 204 may generate and transmit presentation information based on the visit day in the user history information. For example, the generation unit 204 calculates an average value of visit day intervals (for example, one month) based on a plurality of visit days registered in the user history information. Then, the generation unit 204 generates and transmits the presentation information at a timing at which the time of the above average value has elapsed since the latest visit day. The user can thereby receive the presentation information without requesting the presentation information.

### (Fifth Variation)

First information for input and second information for input may be generated by the apparatus 100 based on instructions from the server device 200. In this case, for example, the apparatus 100 stores template information for the first information for input and template information for the second information for input. Then, when the apparatus 100 receives, from the server device 200, instructions for generating individual pieces of information for input and extraction information (for example, the user name, beauty operator name, shop name (area), beauty operator image, and the like) extracted from the user history information and the beauty operator information, the apparatus 100 generates the first information for input and the second information for input in which the extraction information is included in the individual pieces of template information.

### (Sixth Variation)

Service providing persons to be recommended are not limited to beauty operators, and may be, for example, apprentice beauty operators, beauty advisers, manicurists, massagers, trainers, doctors, nurses, professions (for example, lawyers, patent attorneys, and the like), teachers, instructors in lessons and others, writers, bloggers, curators, and so on.

The variations of the present embodiment have been described above. The above variations may be combined arbitrarily.

### <Example of Implementation by a Computer Program>

The embodiment according to the present disclosure has been described in detail above with reference to the drawings. The functions of the apparatus 100, the server device 200, and the network 300 described above (referred to below as the units) may be implemented by a computer program.

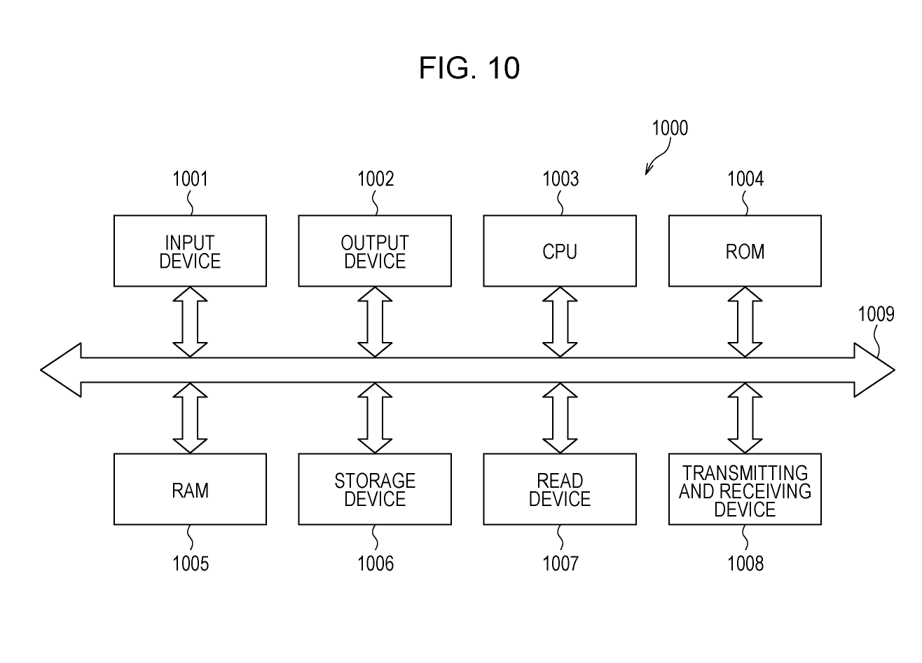

FIG. 10 illustrates an example of a hardware configuration of a computer that implements the functions of the units by a program. The computer 1000 includes an input device 1001 such as an input button or touch pad, an output device 1002 such as a display or speaker, a central processing unit (CPU) 1003, a read only memory (ROM) 1004, a random access memory (RAM) 1005, a storage device 1006 such as a hard disk device or solid state drive (SSD), a read device 1007 that reads information from a recording medium such as a digital versatile disk read only memory (DVD-ROM) or Universal Serial Bus (USB) memory, and a transmitting and receiving device 1008 that performs communication through the network. These units are connected by a bus 1009.

Then, the read device 1007 reads a program for implementing the functions of the units above from the recording medium that records the program, and makes the storage device 1006 stores the program. Alternatively, the transmitting and receiving device 1008 communicates with the server device connected to the network, downloads the program for implementing the functions of the units above from the server device, and makes the storage device 1006 store the program.

Then, the CPU 1003 copies the program stored in the storage device 1006 to the RAM 1005, sequentially reads instructions included in the program from the RAM 1005, and executes the instructions, thereby implementing the functions of the units above. When the program is executed, the information obtained by the various types of processing described in the embodiment is stored in the RAM 1005 or the storage device 1006 and is used as appropriate.

### <Cloud Service Types>

The techniques described in the above embodiment may be implemented in, for example, the following cloud service types. However, types in which the techniques described in the above embodiment are implemented are not limited to the following.

### (First Service Type: In-House Data Center Type)

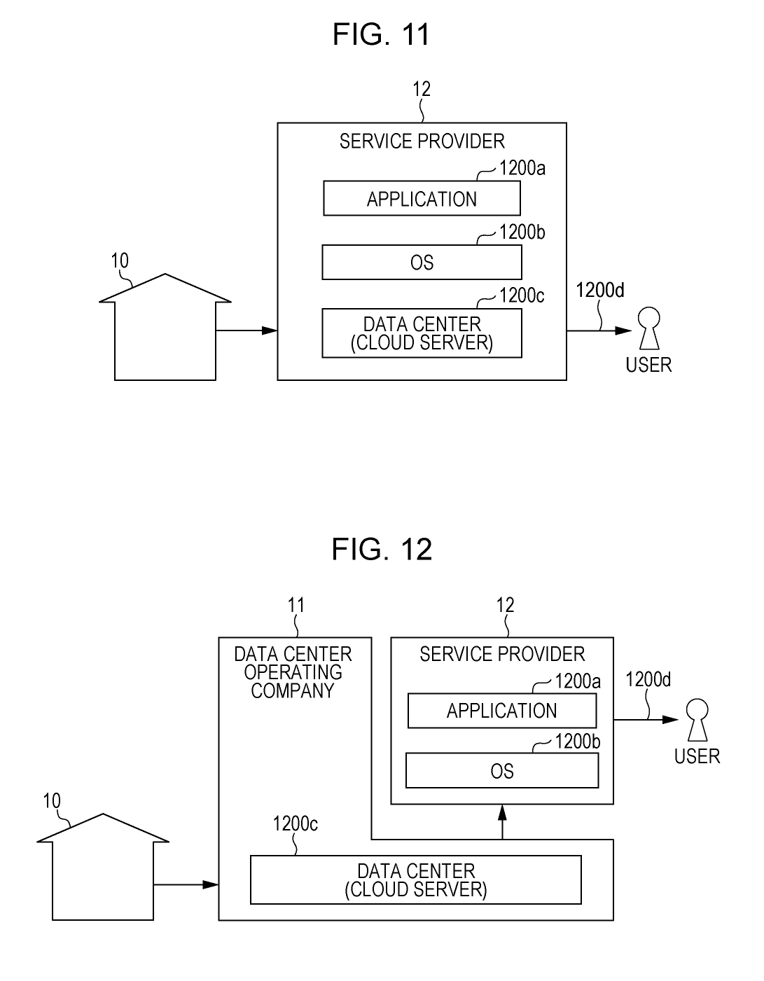

FIG. 11 illustrates a first service type (in-house data center type). In this type, the service provider 12 obtains information from the group 10 and provides the user with a service. In this type, the service provider 12 has the function of a data center operating company. That is, the service provider 12 holds the cloud server 11a that manages big data. Therefore, a data center operating company does not exist.

In this type, the service provider 12 operates and manages a data center (cloud server 11a) (1200c). In addition, the service provider 12 manages an OS (1200b) and an application (1200a). The service provider 12 provides a service (1200d) using the OS (1200b) and the application (1200a) managed by the service provider 12.

### (Second Service Type: IaaS Use Type)

FIG. 12 illustrates a second service type (IaaS use type). IaaS stands for infrastructure as a service, and is a cloud service delivery model that provides an infrastructure itself for building and operating a computer system as a service via the Internet.

In this type, the data center operating company 11 operates and manages the data center (cloud server 11a) (1200c). In addition, the service provider 12 manages the OS (1200b) and the application (1200a). The service provider 12 provides a service (1200d) using the OS (1200b) and the application (1200a) managed by the service provider 12.

### (Third Service Type: PaaS Use Type)

FIG. 13 illustrates a third service type (PaaS use type). PaaS stands for platform as a service, and is a cloud service delivery model that provides a platform that becomes the base for building and operating software as a service via the Internet.

In this type, the data center operating company 11 manages the OS (1200b), and operates and manages the data center (cloud server 11a) (1200c). In addition, the service provider 12 manages the application (1200a). The service provider 12 provides a service (1200d) using the OS (1200b) managed by the data center operating company 11 and the application (1200a) managed by the service provider 12.

### (Fourth Service Type: SaaS Use Type)

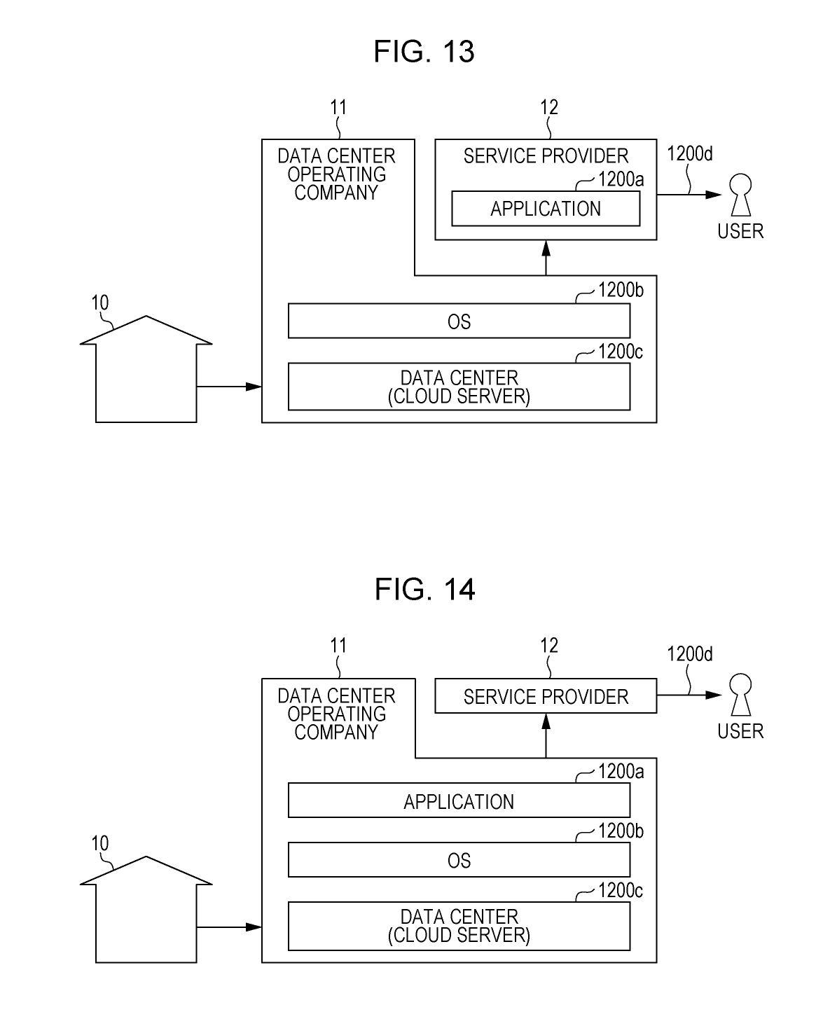

FIG. 14 illustrates a fourth service type (SaaS use type). SaaS stands for software as a service. For example, SaaS is a cloud service delivery model that has the function by which an application provided by a platform provider that holds a data center (cloud server) is made available to a company and individual person (user) that do not hold a data center (cloud server), via a network such as the Internet.

In this type, the data center operating company 11 manages the application (1200a), manages the OS (1200b), and operates and manages the data center (cloud server 11a) (1200c). In addition, the service provider 12 provides a service (1200d) using the OS (1200b) and the application (1200a) managed by the data center operating company 11.

In any of the above types, it is assumed that the service provider 12 provides a service. Moreover, for example, the service provider 12 or the data center operating company 11 may develop an OS, application, database for big data, and the like on its own or outsource them to a third party.

The present disclosure is suitable for use as an information presentation method for presenting a user with information for recommending a service providing person.

What is claimed is:

1. An information presentation method for providing a terminal device with presentation information, comprising:
obtaining first rating information and second rating information, the first rating information being information that is altematively selected by a first user who has received a service from a service providing person, from choices indicating preset ratings for the service providing person, and the second rating information containing keywords that are extracted from text information arbitrarily input by a second user other than the first user and indicate attributes of service providing persons including the above service providing person;
searching for a service providing person to be recommended to the first user, using the first rating information and the second rating information;
generating presentation information for presenting the first user the service providing person to be recommended to the first user found as a result of the search; and
transmitting the presentation information to the terminal device.

2. The information presentation method according to claim 1, further comprising:
searching for the service providing person to be recommended to the first user based on a shop or area specified by the first user.

3. The information presentation method according to claim 1, further comprising:
associating the first rating information is associated with time point information indicating a time point at which the first user received the service from the service providing person; and
calculating average time from when the first user received the service to when the first user receives the service next time, using a plurality of pieces of the time point information for a plurality of pieces of the first rating information, wherein
the presentation information is generated at a timing at which the average time has elapsed since the latest time point at which the first user received the service in the generating.

4. The information presentation method according to claim 1,
wherein the service providing person is a beauty operator, and
the second rating information includes at least any of looks of the beauty operator, a counseling skill of the beauty operator, a conversation skill of the beauty operator, a treatment skill of the beauty operator, and an atmosphere of the beauty operator, as an attribute of the service providing person.

5. The information presentation method according to claim 1,
wherein the second rating information includes an attribute of the service providing person and an attribute value corresponding to the attribute,
the information presentation method further comprising:
deciding the attribute value using the number of times a keyword indicating the attribute is extracted from the text information.
